(19) United States
(12) Patent Application Publication
(10) Pub. No.: US 2012/0278724 A1
(43) Pub. Date: Nov. 1, 2012

(54) CONTROL METHOD OF A TERMINAL DISPLAY DEVICE

(76) Inventor: Yu-Jen Chen, New Taipei City (TW)

(21) Appl. No.: 13/178,515

(22) Filed: Jul. 8, 2011

(30) Foreign Application Priority Data
Apr. 26, 2011 (TW) 100114398

(51) Int. Cl. G06F 3/048; G06F 15/16

(52) U.S. Cl. 715/738

(57) ABSTRACT

A method for controlling a terminal display device is disclosed and includes the following steps. An electronic device couples to a web server of the terminal display device via a network. The electronic device displays a web page transmitted from the web server. A user selects a function option of the web page shown on the electronic device. The web server of the terminal display device generates a command according to the selected function option. A control system of the terminal display device controls an operation of the terminal display device according to the command.

### BACKGROUND OF THE INVENTION

1. Field of the Invention

The present invention relates to a method for controlling a terminal display device, and more particularly, to a method for controlling the terminal display device by selecting a function option of a web page.

2. Description of the Prior Art

Conventional mobile phones are gradually being replaced by touch controlled smart phones embedded with various kinds of software applications. In order to extend application functions of a smart phone to field of a television, the prior art provides a method for converting a wireless network signal or a Bluetooth signal of the smart phone to an infrared signal (IR signal) or a radio-frequency signal (RF signal) compatible with a remote function of the television. Please refer to FIG. 1. FIG. 1 is a diagram showing a portable electronic device 110 controlling a television 120 as disclosed in U.S. patent application number US2009/0239587. As shown in FIG. 1, the portable electronic device 110 installed with a specific application program has a data connection with an intermediary device 140 via a Wi-Fi network 130. After receiving an input command, the specific application program of the portable electronic device 110 transmits a wireless network signal corresponding to the input command to the intermediary device 140. The intermediary device 140 determines an IR signal corresponding to the input command, and emits the IR signal for controlling the television 120. Therefore, a user can install various application programs in the portable electronic device 110 so as to utilize the portable electronic device 110 (such as a mobile phone) to control the television 120 or other electrical appliances. The remote control functions of all household appliances can be further integrated into the portable electronic device 110.

However, the method of controlling the television 120 by the portable electronic device 110 of the prior art still requires the intermediary device 140 to convert the input command of the portable electronic device 110 to the IR remote signal of the television 120. The portable electronic device 110 can not directly interact with the television 120. In addition, the intermediary device 140 can only control the television 120 by transmitting the IR remote signal, which substantially limits interactive behavior between the portable electronic device 110 and the television 120.

Although the prior art also provides a method for utilizing a specific application program of the portable electronic device to interact with terminal display devices, different application programs need to be developed for different platforms of portable electronic devices (such as Android, iOS, Symbian, or Windows Mobile). In other words, the prior art can not provide a general platform as a remote medium that handles interactions between different portable electronic devices and the terminal display device.

### SUMMARY OF THE INVENTION

A method for controlling a terminal display device is disclosed and comprises the following steps. An electronic device couples to a web server of the terminal display device via a network. The electronic device displays a web page transmitted from the web server. A user selects a function option of the web page shown on the electronic device. The web server of the terminal display device generates a command according to the selected function option. A control system of the terminal display device controls an operation of the terminal display device according to the command.

The present invention further provides a terminal display device comprising a web server, an intermediary interface, and a control system. The web server stores at least one web page for generating a command according to a selected function option of the web page. The intermediary interface is for transmitting the command. The control system is for controlling an operation of the terminal display device according to the command transmitted from the intermediary interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a portable electronic device controlling a television disclosed in the prior art.

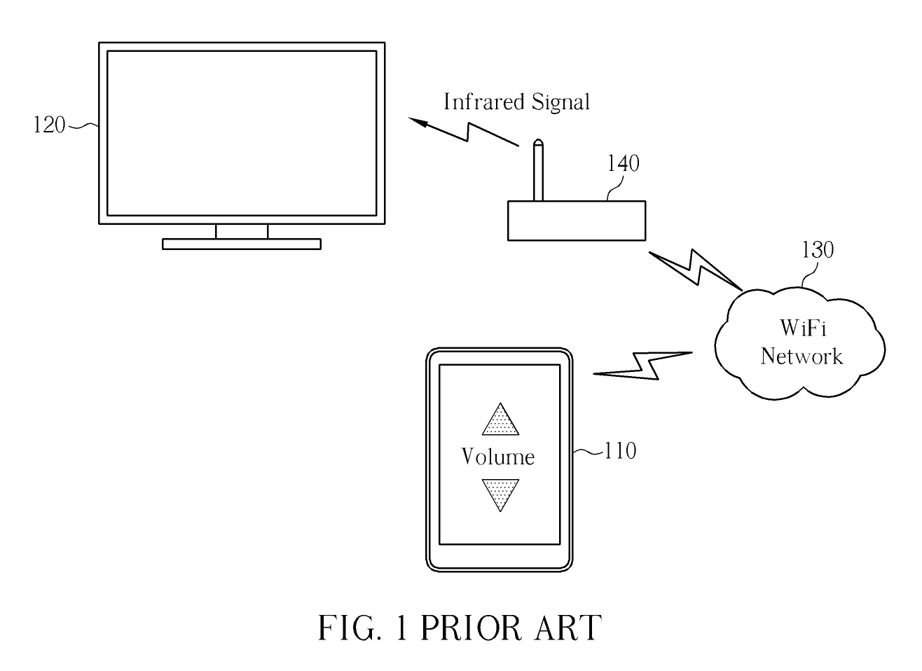

FIG. 2 is a diagram showing a terminal display device of the present invention.

FIG. 3 is a diagram showing the terminal display device of the present invention interacting with a portable electronic device.

FIG. 4 is a diagram showing the terminal display device of the present invention sharing resource with the portable electronic device.

FIG. 5 is a flowchart showing a control method of the terminal display device of the present invention.

### DETAILED DESCRIPTION

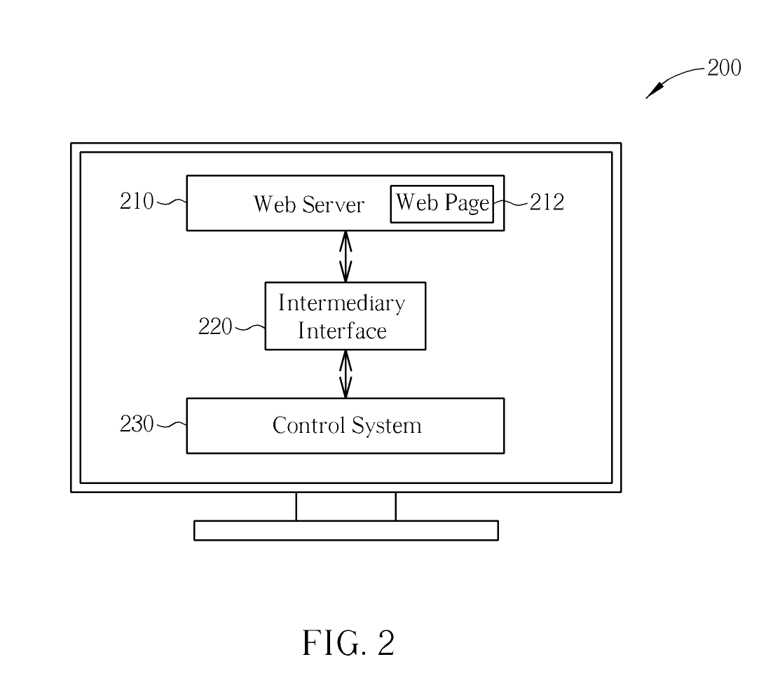

Please refer to FIG. 2. FIG. 2 is a diagram showing a terminal display device 200 of the present invention. The terminal display device 200 of the present invention comprises a web server 210, an intermediary interface 220, and a control system 230. The web server 210 stores at least a web page 212. The web server 210 is capable of generating a command according to a selected function option of the web page 212. The intermediary interface 220 is a communication interface between the web server 210 and the control system 230, where the intermediary interface 220 transmits the command of the web server 210 to the control system 230. The intermediary interface 220 can be built by using web language programs including, but not limited to, PHP or CGI programs. The control system 230 controls a corresponding operation of the terminal display device 200 according to a command transmitted from the intermediary interface 220. The control system 230 comprises a software device and/or a hardware device.

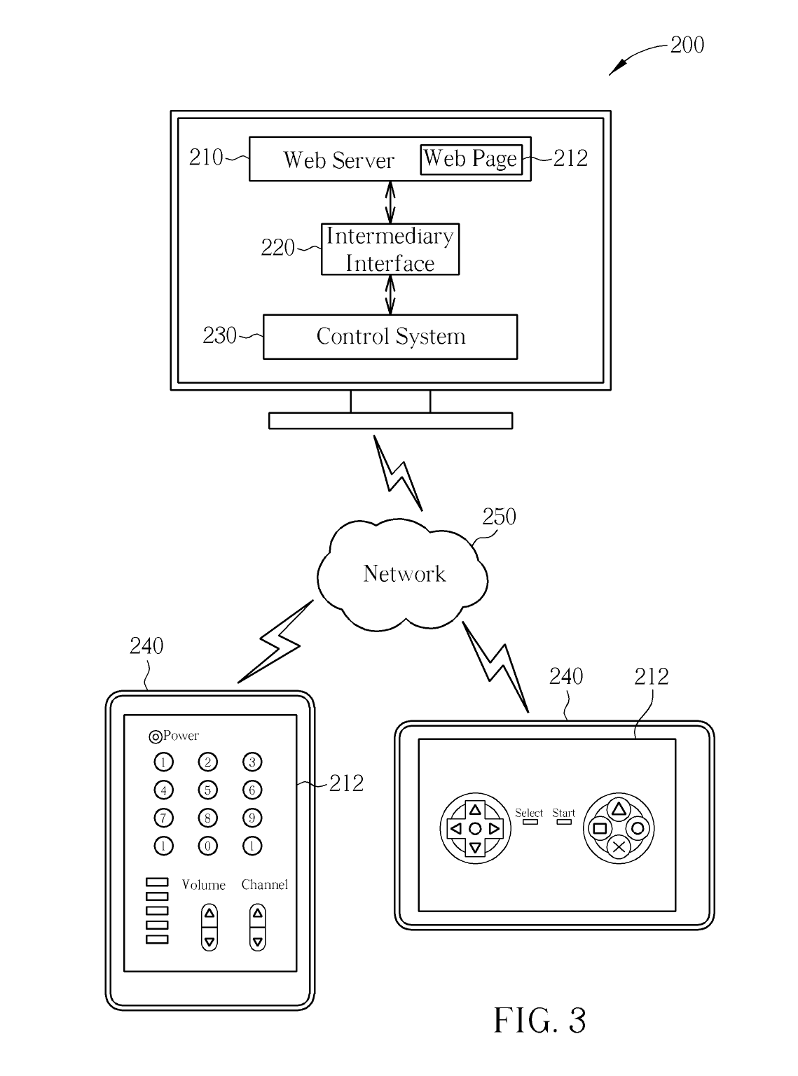

Please refer to FIG. 3. FIG. 3 is a diagram showing the terminal display device 200 of the present invention interacting with a portable electronic device 240. As shown in FIG. 3, the portable electronic device 240 is capable of coupling to the web server 210 of the terminal display device 200 via a network 250 for browsing the web page 212 stored in the web server 210. The network 250 can be a local area network (LAN), an intranet, or Internet. The web page 212 stored in the web server 210 can have various kinds of function options. For example, the function option of the web page 212 can be a function of a button key on a remote controller of the terminal display device 200, such that when the portable electronic device 240 displays the web page 212 transmitted from the web server 210, a user can select the function option (such as volume adjustment, channel selection, or on-screen display) of a button key on the web page 212 displayed on the portable electronic device 240. Thereafter, the portable electronic device 240 transmits a signal corresponding to the selected function option to the terminal display device 200 via the network 250. The web server 210 then generates a command according to the selected function option. The intermediary interface further transmits the command generated by the web server 210 to the control system 230. After receiving the command from the intermediary interface 220, the control system 230 controls the operation of the terminal display device 200 according to the command, for example, adjusting volume, selecting channel, or turning on the on-screen display menu. Therefore, the portable electronic device 240 can easily act as the remote controller of the terminal display device 200 by browsing the web page 212 of the web server 210.

The function option of the web page 212 can also be integrated with other application programs. For example, the function option of web page 212 can be integrated with an application program of an electronic game. When the terminal display device 200 displays the electronic game on screen, the portable electronic device 240 can browse the web page 212 having input options of a joystick of the electronic game. Therefore, the portable electronic device 240 can easily become a joystick of the electronic game by browsing the web page 212 of the web server 210. When the user selects an input option of the joystick on the web page 212, the electronic game displayed on the terminal display device 200 responses correspondingly.

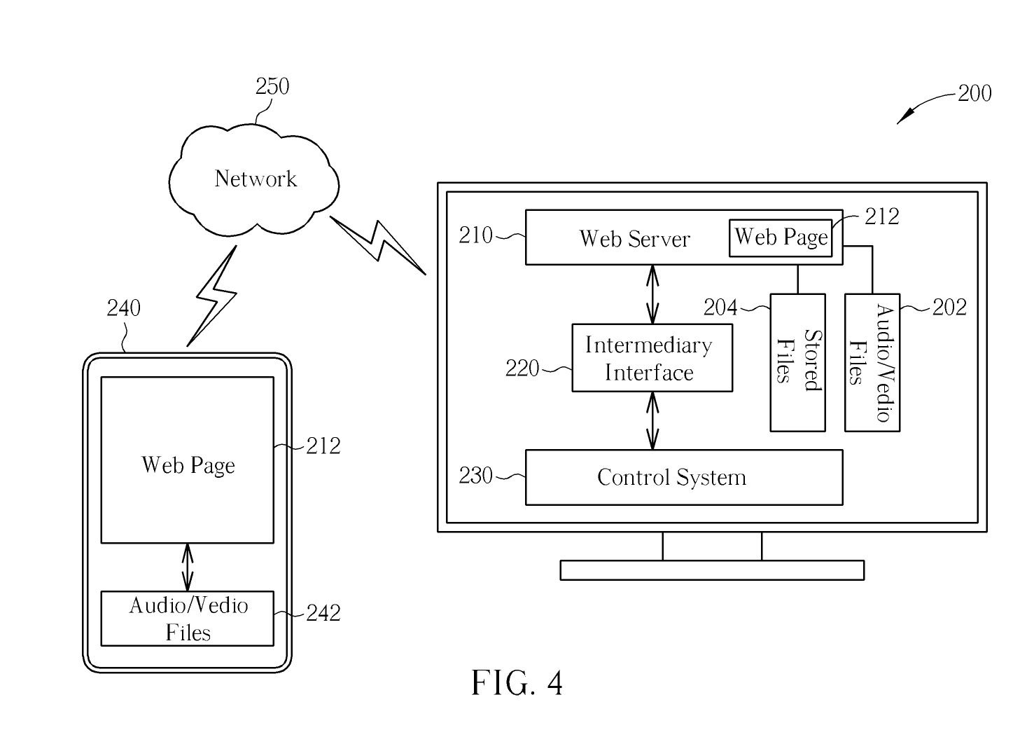

Besides controlling the terminal display device 200, the portable electronic device 240 can also interact with the terminal display device 200 in other modes, such as resource sharing. Please refer to FIG. 4. FIG. 4 is a diagram showing the terminal display device 200 of the present invention sharing resources with the portable electronic device 240. As shown in FIG. 4, the portable electronic device 240 can open a file 204 stored in the terminal display device 200 by utilizing a file-browsing function of the web page 212, or display an audio/video file 202 of the terminal display device 200 on a screen of the portable electronic device 240 by browsing the web page 212 of the web sever 210. Similarly, the portable electronic device 240 can also upload an audio/video file 242 stored in the portable electronic device 240 to the terminal display device 200 via the web page 212, and then the control system 230 can open the audio/video data 242 for being played on the terminal display device 200. Or the portable electronic device 240 can play the audio/video file 242 first, and then upload images of the audio/video file 242 to the terminal display device 200 via the web page 212. Thereafter, the control system 230 controls the terminal display device 200 to display the images of the audio/video file 242 transmitted from the portable electronic device 240.

In addition, the portable electronic device 240 can display the web page in full screen mode or in split screen mode for facilitating the operation. For example, when the portable electronic device 240 displays the web page having function options of a remote controller, the portable electronic device 240 can display the web page in the full screen mode. And when the portable electronic device 240 displays the web page on which the audio/video file 202 of the terminal display device 200 is played, the portable electronic device 240 can display the web page in the split screen mode for facilitating control of playing the audio/video file 202.

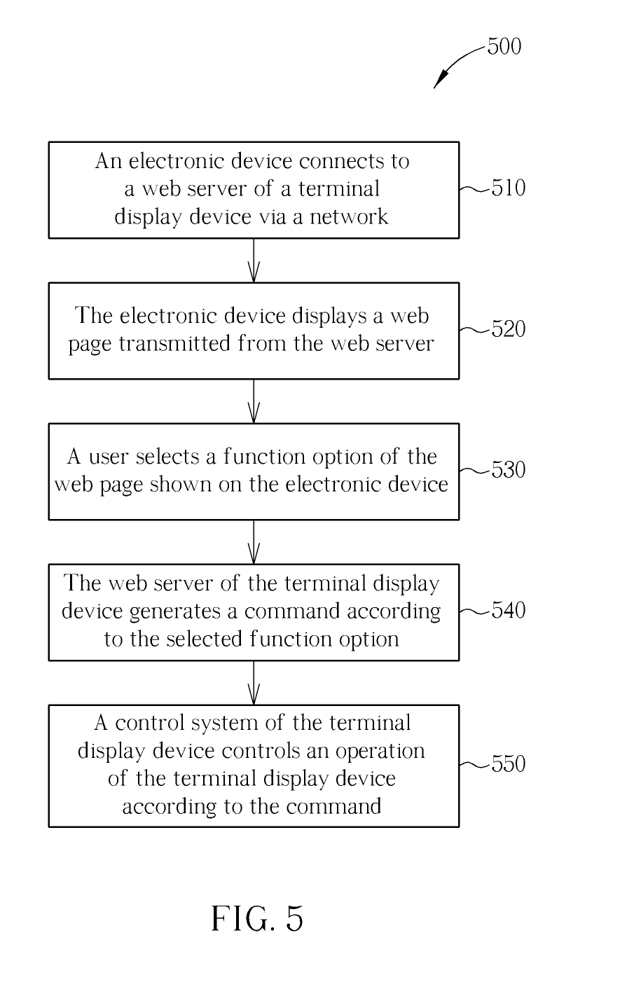

Please refer to FIG. 5. FIG. 5 is a flowchart 500 showing a control method of the terminal display device of the present invention. The flowchart of the control method of the terminal display device of the present invention comprises the following steps:

Step 510: An electronic device couples to a web server of a terminal display device via a network;

Step 520: The electronic device displays a web page transmitted from the web server;

Step 530: A user selects a function option of the web page shown on the electronic device;

Step 540: The web server of the terminal display device generates a command according to the selected function option; and

Step 550: A control system of the terminal display device controls an operation of the terminal display device according to the command.

Basically, the steps of the flowchart 500 need not be in the exact order shown and need not be contiguous. That is, other steps can be inserted there between. In addition, in the above embodiments, the portable electronic device 240 can be a smart phone, a personal digital assistant (PDA), or a tablet personal computer. However, the method of the present invention is not restricted to controlling the terminal display device by the portable electronic device. The method of the present invention can also utilize a desktop computer or other electronic device with Internet access capability to control the terminal display device. The terminal display device 200 is not limited to a television. The terminal display device 200 can be any type of terminal device with a display screen.

In contrast to the prior art, the present invention provides a terminal display device and a method for controlling the terminal display device via a network. The present invention not only provides more kinds of interactive modes between the electronic device and the terminal display device, but also provides a general platform to allow different kinds of electronic devices to control the terminal display device remotely.

Those skilled in the art will readily observe that numerous modifications and alterations of the device and method may be made while retaining the teachings of the invention.

What is claimed is:

1. A control method of a terminal display device, comprising:
using an electronic device to couple to a web server of the terminal display device via a network;
displaying a web page transmitted from the web server on the electronic device;
selecting a function option of the web page shown on the electronic device;
generating a command according to the selected function option by the web server of the terminal display device; and
controlling operation of the terminal display device according to the command by a control system of the terminal display device.

2. The control method of claim 1 further comprising a step of transmitting the command to the control system by an intermediary interface.

3. The control method of claim 1, wherein the function option is a function of a button key on a remote controller of the terminal display device.

4. The control method of claim 1, wherein the function option is an input option of a joystick of an electronic game.

5. The control method of claim 1, wherein the step in which the control system controls operation of the terminal display device according to the command is a step in which the control system controls the terminal display device to play audio/video data of the electronic device according to the command.

6. The control method of claim 1 further comprising displaying audio/video data of the terminal display device via the web page by the electronic device.

7. The control method of claim 1 further comprising the electronic device opening data stored in the terminal display device via the web page.

8. The control method of claim 1, wherein the electronic device displays the web page in full screen mode or in split screen mode.

9. A terminal display device comprising:
a web server storing at least one web page, the web server generating a command according to a selected function option of the web page;
an intermediary interface for transmitting the command; and
a control system for controlling operation of the terminal display device according to the command transmitted from the intermediary interface.

10. The terminal display device of claim 9, wherein the control system comprises a software devise and/or a hardware device.
